(19) United States
(12) Patent Application Publication
(10) Pub. No.: US 2008/0183474 A1
(43) Pub. Date: Jul. 31, 2008

(54) Process for creating and administrating tests made from zero or more picture files, sound bites on handheld device

(76) Inventor: Damion Alexander Bethune, Vauxhall, NJ (US)

Correspondence Address: Damion A. Bethune, 6906 Wynmeadow Drive, Stone Mountain, GA, 30087, US

(21) Appl. No.: 11/700,164

(22) Filed: Jan. 30, 2007

(51) Int. Cl. G10L 13/00

(52) U.S. Cl. 704/260; 704/E13.001

(57) ABSTRACT

Process to record or create sound bites or sound files into test format on a handheld device A preferred embodiment includes a process that can change text to sound bites or files to play back sound file in the form of a test, This includes having one Question and two or more possible answers for the user to choose The process also has a method of redistributing test into one file

### BACKGROUND

1. Field of the Invention

This invention relates generally to the field of educational systems, and more particularly to a process for creating and using tests made from zero or more picture files and sound files to be administered on a open or closed handheld system.

This Process is a hybrid for voice recorder and test system which have both been successful in different ways helping student learn more. A voice recorder allows you to record lectures, test, practically any study material, and lets you go over it at your convenience in as many times you want. This system allows you to study in place where you would not normally study. For instance during jogging, at the gym, in ones daily commute and many other places.

While Computer Based testing does not allow you to study where you wish and the fact you have to keep your full attention on the computer screen when using this method.

2. Description of the Prior Art

The draw back of voice recording is that it is not interactive you could be going over same information you already know wasting time and losing the user interest.

The next draw back of not being interactive is that the material could be very difficult and the user may not be following what is being said once again losing the users interest where interactive device would not. With voice recorder it is hard to go back to the question you are not sure of.

In some cases the user can get lost in the information they are going over from a, voice recording because there is no pause or point where the user can give an input, hence making the user lose interest.

Currently test are not portable not allowing one to study in every situation like a voice recorder could. Tests also requires ones full attention once again losing its portability. In today's world portability means saving time and saving time is every thing. Also test do not allow you to play through question and answers on a portable device.

In the case where voice recordings are not interactive, my system would use a sound bite to prompt the user to answer the question by touching a button on the screen or voice using there own voice to answer the question. This method will not let the user lose portability when using their handheld device

Where voice recordings makes the user go over the same work, my system will not. It will track the answers they gets wrong (a predetermined number of times) and test them on these questions only improving their knowledge of this subject without going over information the user already knows.

When using a computer test, the user has to be engaged in that test in most cases when taking a real test the user must be engaged in that test; but when studying for a test this is not the case. Most peoples lives are so busy that spending many hours in front of a computer, a day is not practical if you are not a full time student.

### OBJECTS

Another object is to format a set of sound files or sound bites for purpose of creating a test

A further object of this invention is to create a system that challenges the user to learn more by issuing verbal queue

Another object is to create a sound driven system where you can manipulate sound from recording, text to speech or the form and present it in a test format

One object to change text to sound to be used to create a test.

Another object that puts all files into one file for easy distribution

Another object that allows you to control the speed of the sound file to help increase your focus and response time

### SUMMARY

A process that allows the user to format sound into a test will allow the user to use text and convert it to sound or use voice recording and make sound files for the purpose of making a test. The use would make sound file of question and a predefined number of answer from this create the test. This process and be put on existing hand held platform (open system examples are Compaq's ipaq, dell's axim or palm's pda) or distributed on a closed handheld system. Meaning it can be sold as a new type of mp3 player or a process for creating and administering test on a handheld device that measure performance and keep record of your performance for the purpose of skipping the questions that you know and focusing on the questions you get wrong.

### BRIEF DESCRIPTION OF THE DRAWINGS

In the drawing figures:

FIG. 1 Is a Flow chart showing the handheld device, utility and how they relate to each other

FIG. 2 Flow chart is showing the Utility to change text to sound files, sound bites or create sound from recording and format files in the form of a audio test for automatic import

FIG. 3 Flow chart is showing the Manual Setup of a test from the handheld device

FIG. 4 The screen shot of the utility program used to quickly change text to speech record sounds, and change sound files into one test format to be down loaded to the handheld

FIG. 5 The screen shot of the Manual Setup of a test from the handheld device

FIG. 6 Screen Shot of an example of a closed system on a hand held device

### DESCRIPTION OF THE PREFERRED EMBODIMENTS

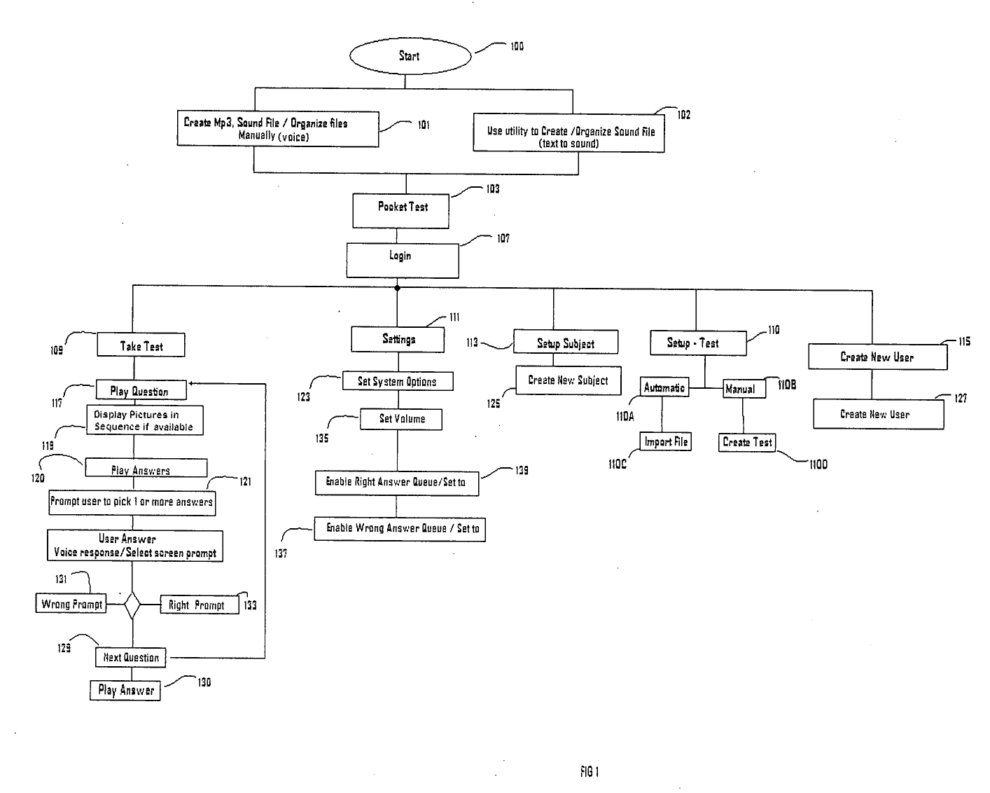

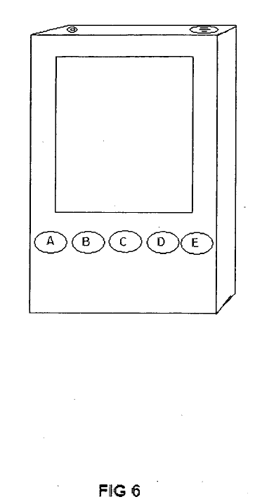

The preferred process is referred to principally in the flow chart shown in FIG. 1. The handheld in the preferred mode of operation, is windows mobile 200x, for the utility or file distribution system a computer system with Windows platform. The handheld is envisioned to also operate on palm platform, and a closed system. Handheld closed systems are devices such as portable mp3 players, alarm systems, phones as seen in FIG. 6. The utility or file distribution system is also envisioned to operate on Macintosh and OS2 platform.

FIG. 6 shows an example of a closed system. This is a device which was created primary to use this process. Unlike ipaq, dell handhelds there can be addition accessories or software added to these handheld system where in a closed system you can not have additional software or utilities.

FIG. 1 the Pocket Test as seen in element 103 you open the program and login to the test, login the handheld will be able to keep track of the users progress and the user will be able to go over new material they need help with because the system will remember how well they did the last time.

After login, the user can take a test, adjust the system setting, create a new subject create a new test, and create new user. The adjusting of the system settings include features like selecting the right or wrong threshold where for example if the user gets the problem wrong a certain amount of times, this is considered a problem area for the user. They will be asked this question repeatedly until they get it right a certain amount of times; after which this question will be treated as learned knowledge and the user will not be asked this question again. The setting feature can also control the speed of the sound file playing the quality of the sound and image played and displayed

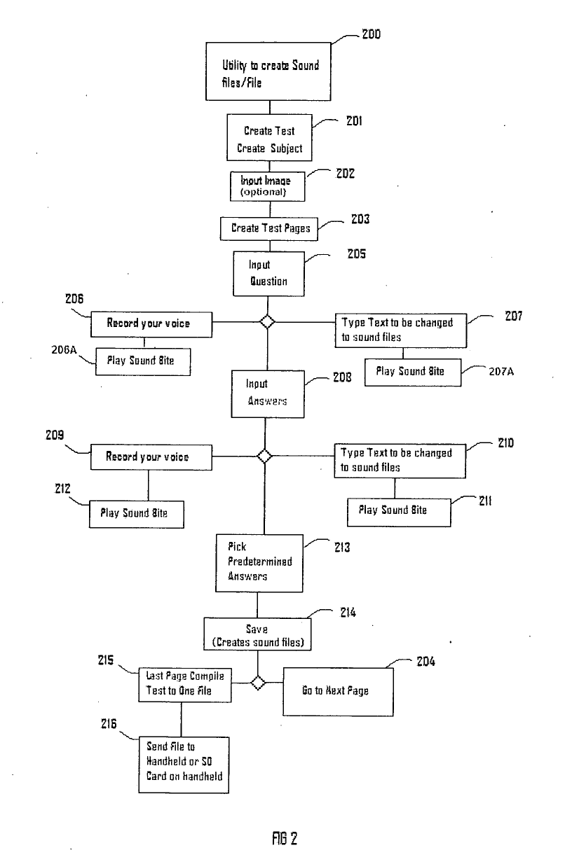

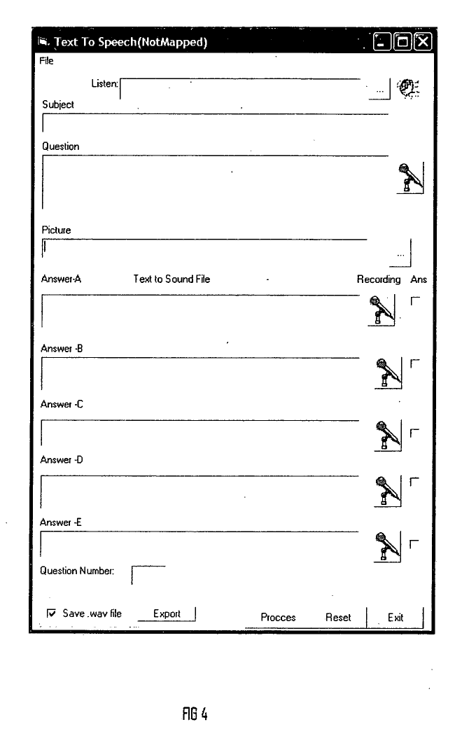

The user can create and organize sound files manually by using a separate text to speech utility, a separate sound file recorder or use the one that come in this system. As seen in FIG. 1 element 101 or element 102 which is the utility that comes with this system. AS seen in FIG. 2 which is a continuation of FIG. 1 element 102 shows the Desktop utility user for fast import into the handheld device as seen in screen shot of FIG. 4. When using this device for input the user can play a sound bite to hear them before saving them as shown in 206a,207a, 212 and 211. When inputting question and answers the user has a choice of using a voice recording or changing text to speech. After inputting the Question and answers the user then picks predetermined answer like in a multiple choice test. After inputting this information the saves each page of the test until reaching the last page where they can compile the test creating one folder or file in that can be put on a server and download from the handheld, transfer from server to handheld by a synching method or put on a SD card.

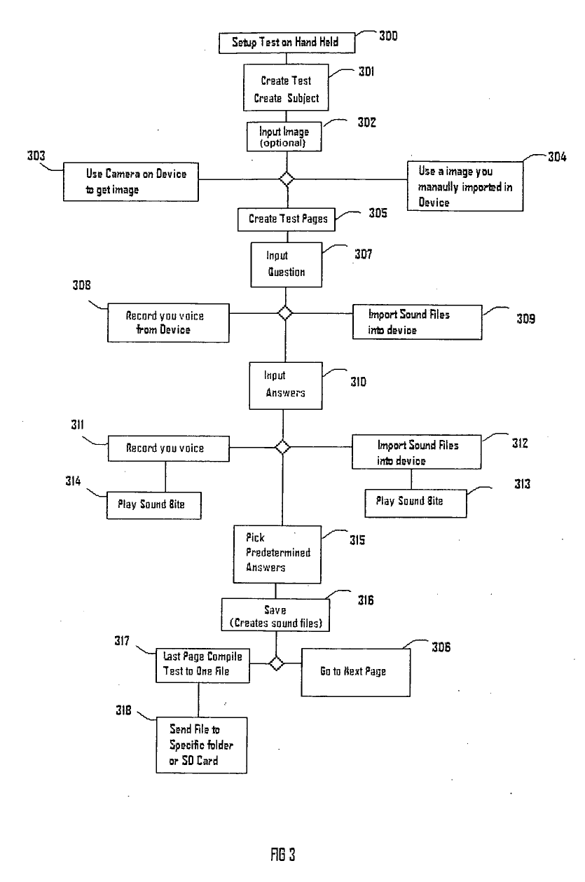

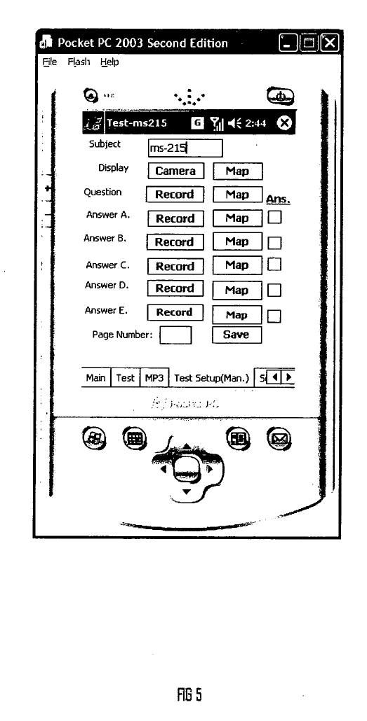

FIG. 1 element 110 the Setup Test element which is the same as the Setup Test element in FIG. 3 element 300 allows the user to manually create test on the handheld device as seen in FIG. 5 screen shot. The user would create the test subject then use the camera on the portable handheld device (for example pda with camera or more populate pda phones with camera) and use that picture if a camera is not available the user can input the image as shown in FIG. 3 element 304 manually by copy the image onto the device and mapping the image. If no image is available the user can go to the next step and input the answers element 310. After the question and all answers have bin input

This system is not limited to a multiple choice, or true and false test since the user can use voice input to make there choices.

The clear advantage to this system is portability and interactivity; which in short will keep the user studying in places they would normally not be able to study. Interactivity will keep the user focused on what they are learning. Interactivity also allows to program to track what question the user need the most work on and keep the user focus on the areas they need help in. The combination of these three thing will make studying more effective, increase there chances of passing the test and learning experience more enjoyable one.

What is claimed is:

1. A Process to record create sound files into test format on a handheld device

2. A process as claimed in claim 1, further including a process can change text with means to sound files to play audio prompts.

3. A process as claimed in claim 1, further including a process with means to displays zero or more images.

4. A process as claimed in claim 1, further including a process enables each test a means to be automatically downloaded from one or more files for distribution.

5. A process as claimed in claim 1, further including a process which provides a means to plays songs.

6. A process as claimed in claim 1, further including a process with means to responds to the user voice to answer questions posed or perform tasks.

7. A process as claimed in claim 1, further including a process with means to change sound bites into a test format.

8. A process to format sound file into test format

9. A process as claimed in claim 8, wherein said process is on a closed system.

10. A process as claimed in claim 8, wherein said process is on a open system.

11. A process as claimed in claim 8, wherein said process can be on PDA, PDA Phone or phone.
